(19) United States
(12) Patent Application Publication
(10) Pub. No.: US 2012/0296700 A1
(43) Pub. Date: Nov. 22, 2012

(54) MODELING THE TEMPORAL BEHAVIOR OF CLIENTS TO DEVELOP A PREDICTIVE SYSTEM

(75) Inventors: Chebiyyam V.V.N.S. Murthy, New Delhi (IN); Sameep Mehta, New Delhi (IN)

(73) Assignee: INTERNATIONAL BUSINESS MACHINES CORPORATION, Armonk, NY (US)

(21) Appl. No.: 13/112,710

(22) Filed: May 20, 2011

(51) Int. Cl. G06Q 10/00

(52) U.S. Cl. 705/7.32; 705/7.11

(57) ABSTRACT

A method, system and computer program product are disclosed for modeling the temporal behavior of clients to develop a predictive system to influence client relationships. In an embodiment, the method comprises establishing for each of a plurality of clients a temporal model for a given time period, and the temporal model identifies a plurality of factors as contributing to a specified relationship with the each client over the given time period. For each of a plurality of different stages of the given time period, the temporal model identifies one or more of these factors as contributing to the specified relationship with the each client. One of the clients is identified as a model client for another client, and the temporal model of this model client is used to predict one or more of the plurality of factors as contributing to a specified relationship with this another client at a specified time.

### BACKGROUND OF THE INVENTION

The present invention, generally, relates to client relationship management (CRM) in a business-to-business context. More particularly, this invention relates to methods, systems and computer program products to model the temporal behavior of clients to develop a predictive system to influence positively client relations.

### BRIEF SUMMARY

Embodiments of the invention provide a method, system and computer program product for modeling the temporal behavior of clients to develop a predictive system to positively influence client relationships. In an embodiment, the method comprises establishing for each of a plurality of clients a temporal model for a given time period. The temporal model identifies a plurality of factors as contributing to a specified relationship with the each client over the given time period. For each of a plurality of different stages of the given time period, the temporal model identifies one or more of these factors as contributing to the specified relationship with the each client. The method also comprises identifying one of the clients as a model client for another client, and using the temporal model of this model client to predict one or more of the plurality of factors as contributing to a specified relationship with this another client at a specified time.

### BRIEF DESCRIPTION OF THE SEVERAL VIEWS OF THE DRAWINGS

FIG. 1 shows a method in accordance with an embodiment of the invention.

FIG. 2 illustrates a chart that identifies various attributes affecting client loyalty at different stages of an account.

FIGS. 3A-3C show a template that may be used to conduct a client survey.

FIG. 4 shows several charts that illustrate one example of the relationship between client loyalty and revenue growth.

FIG. 5 depicts revenue and a loyalty measurement for several clients over a number of years.

FIG. 6 lists features or principals that are used in or with embodiments of the invention.

FIG. 7 shows a number of attributes that affect client loyalty, and sub-parameters of those attributes.

FIG. 8 shows a computing environment that may be used to implement this invention.

### DETAILED DESCRIPTION

As will be appreciated by one skilled in the art, embodiments of the present invention may be embodied as a system, method or computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The present invention relates to modeling the temporal behavior of clients and to developing a predictive system to influence positively client satisfaction and loyalty in a business-to-business relation. The invention is based on the principal that the need and expectation of the client changes over time. In accordance with this principal, in order to develop an appropriate model for achieving client satisfaction and loyalty, the age of a client account should play an important role both while modeling and while predicting. Also, it is important to recognize that the factors/attributes affecting the client satisfaction and loyalty will change year-over-year.

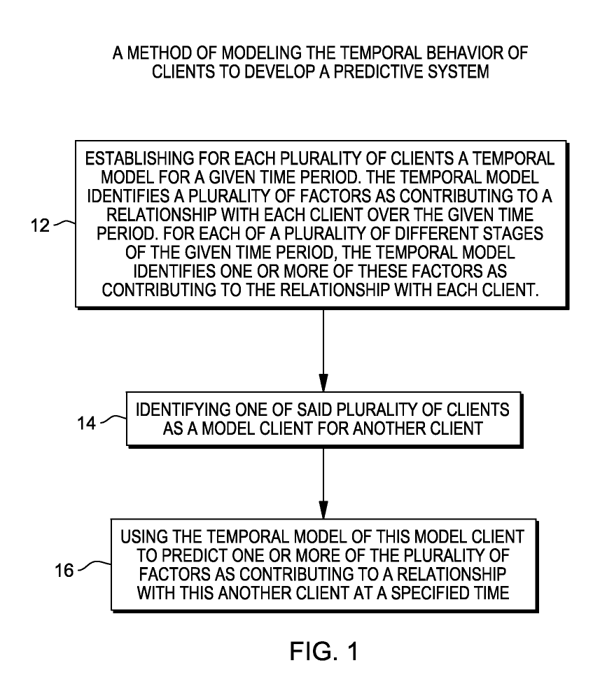

FIG. 1 illustrates a method in accordance with an embodiment of the invention. At step 12, a temporal model is established for each of a plurality of clients for a given time period, and this temporal model identifies a plurality of factors as contributing to a specified relationship with the each client over the given time period. For each of a plurality of different stages of the given time period, the temporal model identifies one or more of the factors as contributing to the specified relationship with the each client. At step 14, one of the plurality of clients is identified as a model client for another client; and at step 16, the temporal model of this model client is used to predict one or more of the plurality of factors as contributing to a specified relationship with said another client at a specified time.

In an embodiment, the temporal models are established by surveying the plurality of clients at least a plurality of times. For each of the plurality of clients, the surveys are used to measure a set of defined factors, and these defined factors are used to develop the temporal model for the each client. In one embodiment, each of these defined factors includes one or more sub-parameters.

In an embodiment, the method further comprises calculating a defined client loyalty value for each of the plurality of clients from one or more of the factors identified as contributing to the relationship with said each client. In one embodiment, the client loyalty value is calculated using a defined equation. In one embodiment, the method further comprises setting a target value for the client loyalty value.

In an embodiment, this defined equation includes, for each of the plurality of clients, variables representing all of the factors identified as contributing to the relationship with said each client. In one embodiment, the only variables in said defined equation represent the factors identified as contributing to the relationship with said each client.

In one embodiment, each of the clients has a respective one account, and said specified time is a specified age of the account of the another client. In an embodiment, the temporal model of the model client is used, before the account of the another client reaches this specified age, to predict the one or more factors as contributing to the relationship with the another client when the account of the another client is at the specified time.

In an embodiment of the invention, for each client (or a set of clients) at the same account age level, the attributes are discovered which are important from a customer satisfaction and loyalty point of view. For example, it may be discovered that for a client “C” in the 5^{th} year of an account, the important attributes are: A (at level=3) and B (at level=4). These levels may, for example, be captured when the client answers a survey.

Next another client D with an account age of 4 years is found that matches client “C”. the service provider for client D should focus on attributes A and B to increase satisfaction and loyalty. In essence, account D in the 5^{th} year of the account, should emulate account C.

A “temporal model” is a model that describes the client relationship status with a long-term perspective such as two or more years, rather than a cross-sectional, one time view. For example, in one study, the client satisfaction data was collected for a given client during several years (example: 4 years) and multiple times (example: 2 times per year). As the model is developed based on the data over a long period of time, the model describes the client relationship status with a long term perspective rather a cross-sectional one time view.

The satisfaction of the client on the over-all contract performance may be measured based on various attributes. These attributes (referred to as independent variables) may be different for different service offerings, and each of these attributes can be divided into one or more sub-attributes or next-level attributes, as discussed below.

In an embodiment of the invention, the client loyalty is the intent and action of the continuing business relationship by the client organization. The intent can be measured through the client response to given questions such as “Would you like to continue working with the service provider for additional process needs of your organization.” The action of the continuing business relationship can be measured through the change, or delta increment, of annual revenue for a given client for a given year in comparison with the previous year.

The “stage” of the temporal model refers to a point in time during the provider/client relationship. As this is a temporal study, a continuous change can be expected in the maturity of the client relationship. In a multi year contract, every year or every contract renewal can be considered as a stage. Also, every time the client satisfaction is captured through a survey can be considered as a stage.

Client satisfaction and client loyalty are related in that client satisfaction is the cause and Client loyalty is the effect. The more satisfied the client is with the contract performance and relationship, the greater the possibility for the client to be loyal to the service provider.

The present invention can be used in many different contexts and in many different specific environments. As discussed below, embodiments of the invention are particularly well suited for modeling and using the temporal behavior of clients in a business-to business relationship. As used herein, the term “business-to-business relationship” generally refers to a generic business-to-business relationship. It will be appreciated, however, that business-to-business relationships, as used herein, can include enterprise IT solutions, large scale infrastructure projects, construction projects, financial services, research and consulting projects, and other projects.

In one embodiment of the invention, younger accounts can follow in the footsteps of successful, mature accounts. This helps the service provider focus on the right area at the right time—that is, the service provider is able to identify at different times, the factors/attributes that are most important to the client at each of these times, and to provide the appropriate services, at each of these times, that will maximize client satisfaction and loyalty.

With an embodiment of the invention, based on predictive cues, the organization can set targets which should be met for each important attribute. With reference to the above example, for account D, the attributes A and B should be at least at level 3 and 4 respectively. This is derived based on a predictive model that says account D should emulate account C.

For instance, during the early years of a contract or account, the client may put more weight on “operational efficiency,” while in later years of the contract, “value addition” may be the most factor most important to client satisfaction and loyalty.

As another example, an account A, in its fourth year, may put more emphasis on “value addition” than it had in its previous years. Another account B, which is in its third year, may be showing a growth trajectory similar to that of account A. Based on the history of account A, the Project Executive of account B can, as the fourth year of this account begins or is about to begin, proactively start looking at improving value addition aspects of account B to grow that account and to maximize client satisfaction and loyalty.

As a more specific example, client survey data covering the years 2005-2008 were taken for ten accounts of large delivery organizations. Two surveys were taken each year, from multiple respondents from each account. Revenue figures were also taken for each account from 2005-2008.

In the surveys, eleven independent and three dependent variables were measured, with each independent variable having one or more sub-parameters. These variables are given in the table below.

TABLE I
Independent Variables

| | |
|---|---|
| 1. | Operations and Workflow management |
| 2. | Service & Quality |
| 3. | People |
| 4. | Change Management |
| 5. | Information Technology |
| 6. | Security & Compliance |
| 7. | Responsiveness & Communication |
| 8. | Customer Service Orientation |
| 9. | Financial |
| 10. | Value Addition |
| 11. | Client Relationship Management |

Dependent Variables

| | |
|---|---|
| 1. | Client Loyalty |
| 2. | Business Recommendation |
| 3. | Revenue Growth |

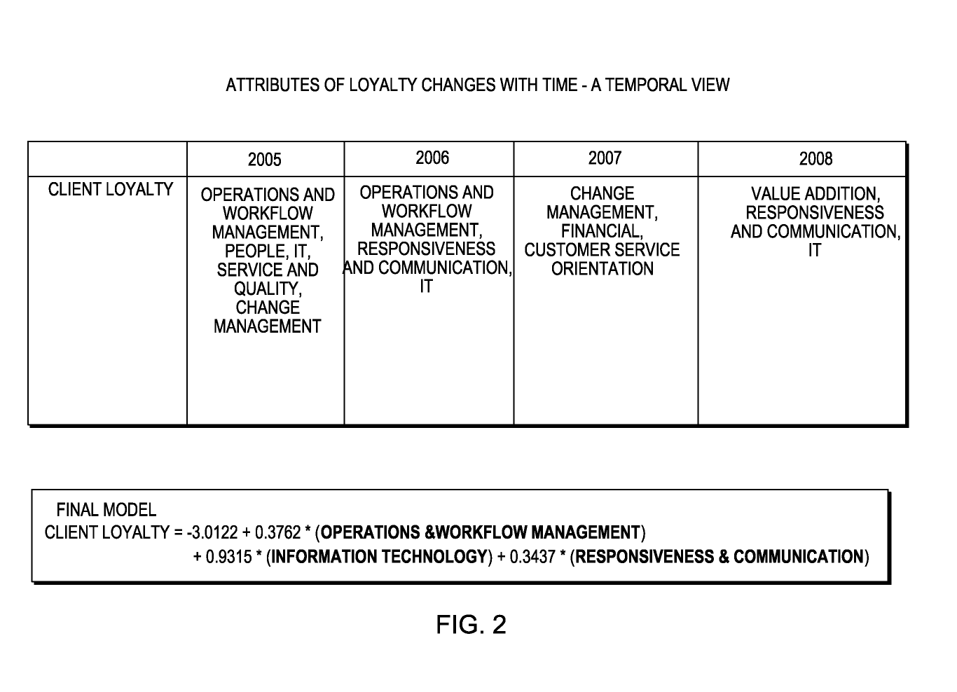

The chart of FIG. 2 shows how the variables that were most important to developing client loyalty changed over time. In 2005, a number of variables were important, including Operations and Workflow Management, People, IT, Service and Quality, and Change Management. In 2006, the most important variables were Operations and Workflow Management, and Responsiveness and Communication. In 2007, the most important variables had become Change Management, and Financial Customer Service Orientation; and in 2008, the most important factors were Value addition, Responsiveness and Communication, and IT.

As the chart illustrates, there was a significant change over time in the most important variables over time. For example, most of the variables that were most important in 2005 were not among the most important variables in 2008. Moreover, of the three variables that were most important in 2006, only one was among the list of most important variables in 2005.

The chart of FIG. 2 thus shows that in order for a service provide to achieve high levels of client satisfaction over a length of time, it is critical that the service provider change its focus. The service provider needs to focus on the right area at the right time.

FIG. 2 also shows an equation that may be used to determine a value for client loyalty. Using this equation, the client loyalty in 2008 is calculated by:

Client Loyalty=−3.0122+0.3762*(Operations & Workflow Management)+0.9315*(Information Technology)+0.3437*(Responsiveness & Communication).

This equation is an example of model fitting. Any statistical technique can be used to derive such equations like regression, step-wise regression or factor analysis. The model essentially captures the impact of each attribute by the use of weights. The actual values of the attributes (on the right hand side of the equation) are based on results of a survey and the value of the equation is computed. The value indicates client loyalty.

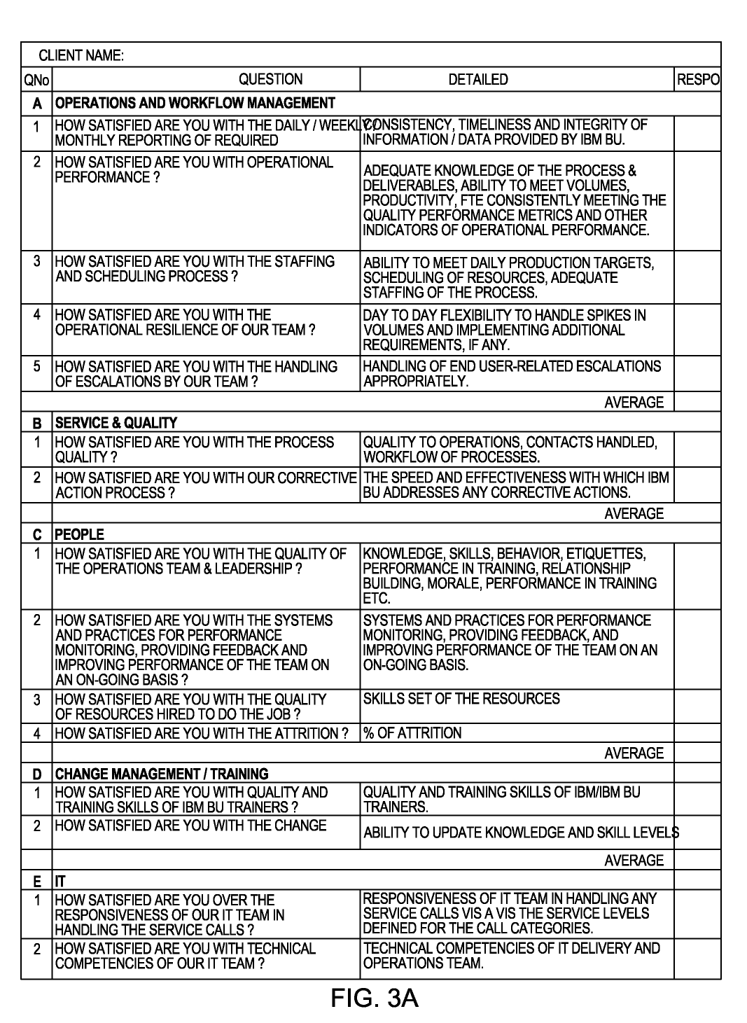

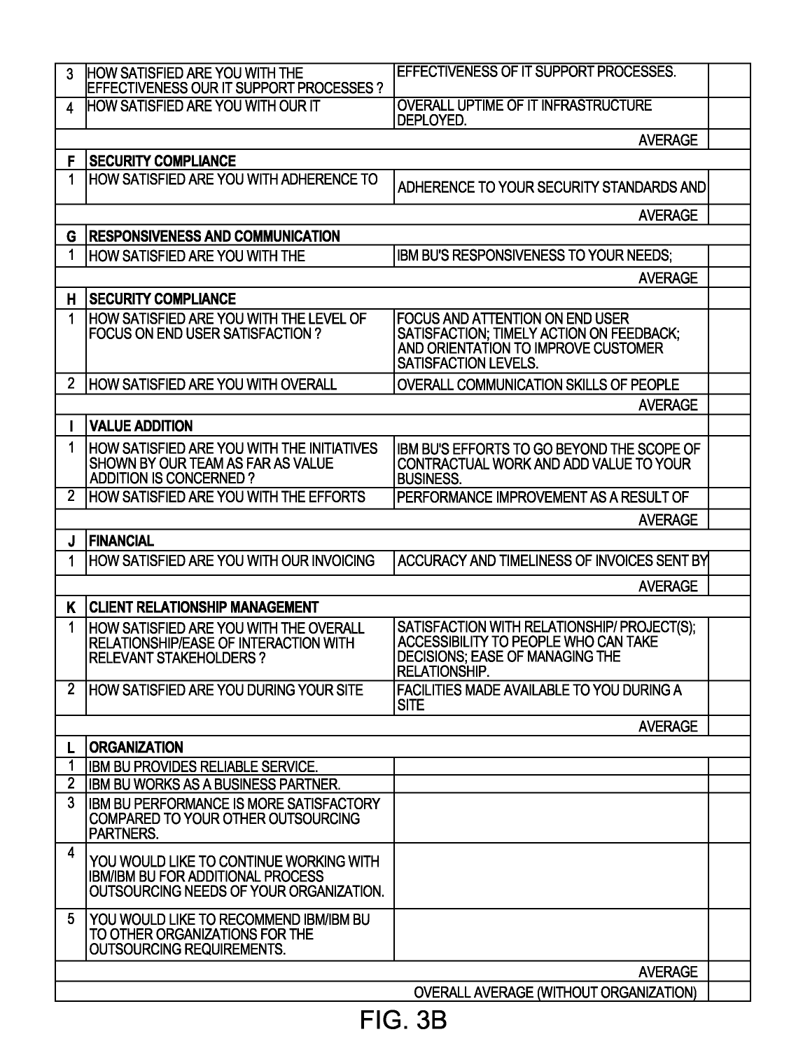

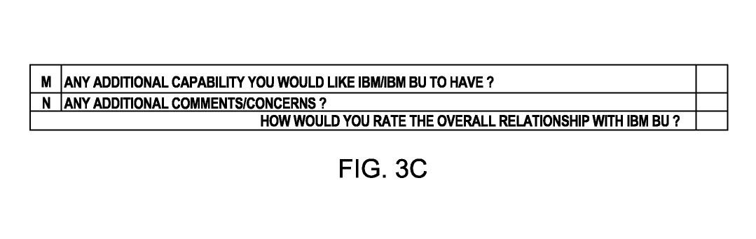

In this equation, the numbers are derived by some statistical method. For example, in an embodiment, logistic regression may be used. However, simple regression, Principal Component Analysis (Factor Analysis) can also be used. The factors can be converted into numbers in the following fashion. While doing the survey, the data is collected from clients under each heading (for example Operations and Workflow Management, as shown in FIG. 3A). The client answers five questions and gives a rating of one to five or ten for each question. The ratings for the five questions are averaged to find one number for Operational efficiency. Averaging is just one example. Other values such as min, max, median values can also be used.

The areas like Operations and Workflow Management, and People are called independent variables. An important feature is that the value of one independent variable cannot be deduced/derived/dependant on another variable. Independent variables can be what the survey is based on; and, for example, People and Operations and Workflow Management may be independent variables.

As one example, FIGS. 3A-3C show a survey template that may be used. This template uses the “Independent variables,” such as “People,” “Financial” and “Client Relationship Management.” Each question under one of the independent variables is measured based on the client (respondent) feedback. In addition to the performance feedback on each independent variable, the feedback is obtained on the dependent variable, for example: “client loyalty” (Considering for additional process needs of client organization), and “Referenceability” (recommend the service provider to other organizations). In this example, client loyalty is measured through the question L4 in FIG. 3B.

In one embodiment, the model of FIG. 2 was built based on the temporal analysis (historical data over 5 years) for multiple accounts. Values are determined for the variables that represent the parameters for which the client feedback is collected in the survey. These variables are also referred to as independent variables. Based on values of these variables, dependent values, for example, client loyalty, can be computed. In such case, client loyalty is a dependant variable (derived from others).

The numbers in the equation in FIG. 2 are obtained as follows. Based on the Survey in FIG. 3, we have the following as independent variables:
Operations and Workflow Management;
Service & Quality;
People;
Change Management and Training'
IT;
Security Compliance;
Responsive and Communication;
Customer Service Orientation;
Value Addition;
Financial; and
Client Relationship Management.

The client is asked to fill this survey and rate the service provider on scale of 1 (poor) to 5 (excellent). The scale can be varied as well.

Furthermore, the client is asked the following questions (rated on the same scale as above, or these questions can be yes or no questions):
How satisfied are you with service? (This is a measure of Customer Satisfaction);
Would you give more/new business to service provider? (This is a measure of Customer Loyalty); and
Would you recommend service provider? (This is a measure of Customer Referenceability).

These variables—Customer Satisfaction; Customer Loyalty; and Customer Referenceability—form the dependant variables. The questions can vary from survey to survey but they are intended to capture the outlook toward Customer Satisfaction and Loyalty. We wish to learn how the independent variables can be combined to predict the dependant variables.

Once the data is obtained, we can use any model fitting algorithm to find important attributes and how they relate to output. The important attributes can be discovered using, for example, Factor Analysis. Factor analysis is an statistical technique to map a high number of independent variables to a low number of dependent variables such that the least information is lost in prediction of the dependant variables. More information on factor analysis can be found on the Wikipedia Website, under “Factor Analysis.”

One can use regression (as one example) for this purpose, where the independent variable are appropriately weighted to produce the output. One example is the following, generated from using regression as a model fitting tool. Regression is standard statistical technique which is used to estimate relationship between independent and dependant variable. More information about regression analysis can be found on the Wikipedia website under “Regression Analysis.”

Client Loyalty=−3+0.3762*(Operations & Workflow Management)+0.9315*(Information Technology)+0.3437*(Responsiveness & Communication).

Now assume, a new client gives the following score:
Operations and Workflow=4;
Information Technology=3;
Responsiveness and Communication=3.

The numbers can be put into the equation in FIG. 2 as follows:

Client Loyalty=0.3+0.3762*4+0.9315*3+0.3437*3

This will give the client loyalty score as: 2.3.

It may be noted that factor analysis and regression demonstrate one way of modeling. There are other modeling mechanism that may be used in embodiments of the invention.

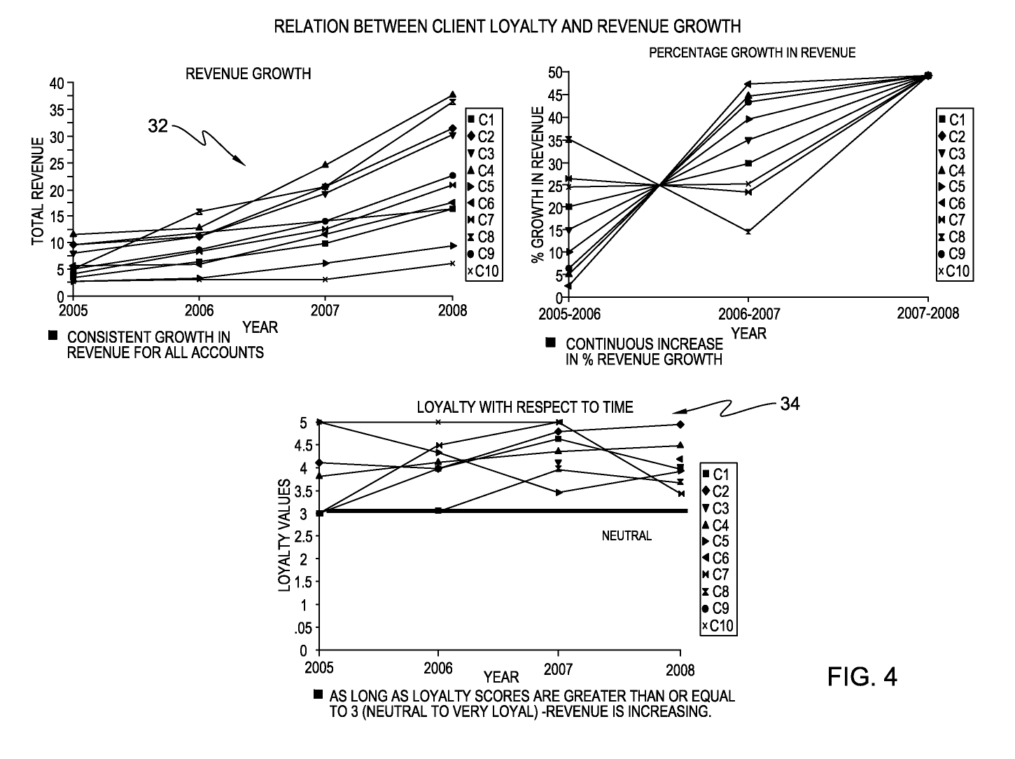

FIG. 4 illustrates the relationship, in one study, between client loyalty and revenue growth. In this example, there was, as shown at 32, consistent growth in revenue for all the accounts. Also, as shown at 34, the client loyalty was consistently above a score of 3, indicating neutral to very loyal.

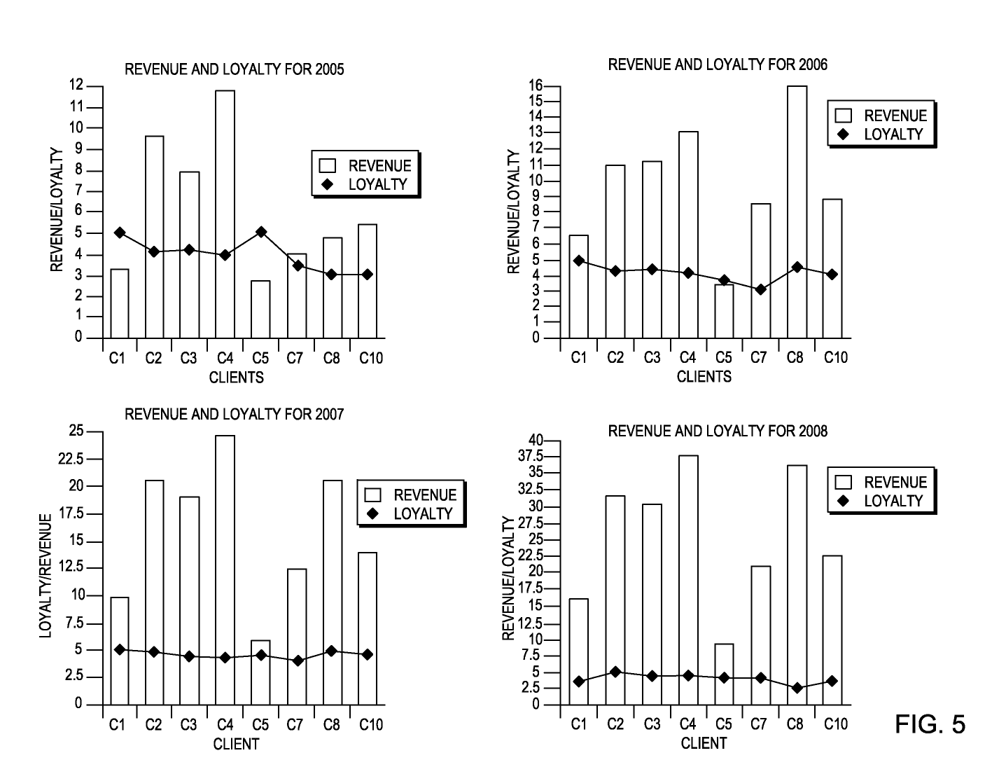

FIG. 5 shows, as one example, the revenue and measured loyalty for each of eight clients for each of the years from 2005 to 2008. As this Fig. illustrates, revenue is non decreasing for all the clients across the years; and, as long as loyalty scores for a client are greater than or equal to three (neutral to very loyal), revenue is increasing for that client.

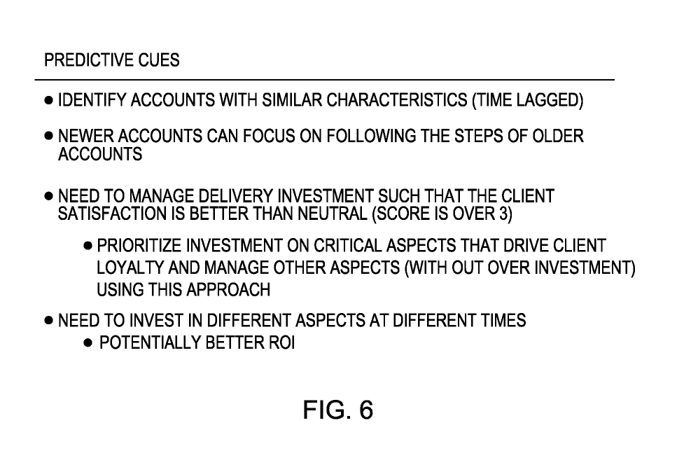

FIG. 6 identifies important principals or features that are used in embodiments of the invention to provide predictive cues. These principals include identifying accounts with similar, but time lagged characteristics—that is, the two accounts have similar characteristics, but one client is further along in time than the other client.

Under these circumstances, the newer account can focus on following in the steps of the older account. Specifically, when one account reaches a certain point in time, the executive for that account can focus on factors that earlier were important to client satisfaction and loyalty with another, similar account at a similar or corresponding point in time.

As the charts of FIGS. 4 and 5 show, there clearly is a need to manage delivery investment such that the client satisfaction is better than neutral (score is over three). To achieve this, it is important to prioritize investment on critical aspects that drive client loyalty and to manage other aspects (without over investment) using the approach of the present invention.

A critical point, which the present invention helps the service provider achieve, is the need to invest in different aspects at different times in the account. This potentially results in a better return on investment.

In accordance with embodiments of the invention, for each of the high level constructs (such as shown in Table I), similar techniques can be applied to further drill down on sub parameters. Using this, the investment and the improvements in an account can be even more directed.

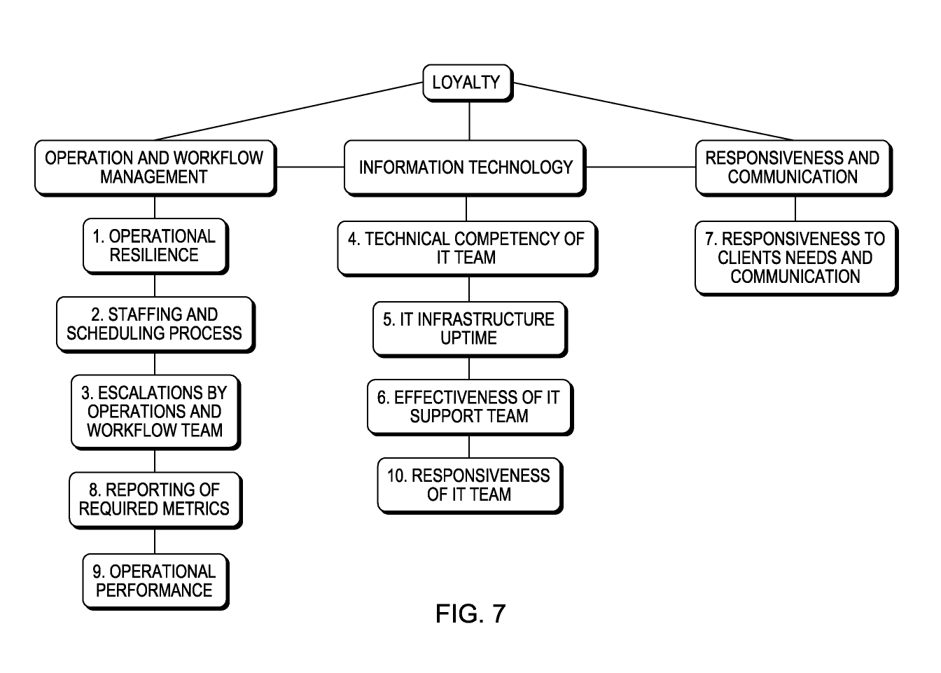

FIG. 7 illustrates, as an example, a number of variables and sub-parameters that may be used to measure client loyalty. In particular, this Figure shows three parameters: Operations and Workflow Management, Information Technology, and Responsiveness and Communication. Operations and Workflow Management includes: Operational Resilience, Staffing and Scheduling Process, Reporting of Required Metrics, and Operational Performance. Information Technology includes Technical Competency of IT Team, IT Infrastructure Uptime, Effectiveness of IT Support Team, and Responsiveness of IT Team. The Responsiveness and communication variable includes, in the example shown in FIG. 7, only one sub-parameter—Responsiveness to Client Needs and Communications.

Embodiments of the invention provide important advantages in a business-to-business relation. The business model may be (i) a multi-year long term contract with high TCV, or (ii) a short term contract repeatedly extended. In both cases, the successful and profitable growth of the contract depends on client loyalty.

This model helps service delivery organizations prioritize drivers for client loyalty at both macro and micro levels. The model facilitates strengthening the delivery organization's hard and soft infrastructure to meet minimum expectations of the client. Based on this model, Delivery Managers can focus the investment of time and cost to meet client expectations on a continuing basis. The model may be used to ensure continuity of contract and also to help achieve revenue growth.

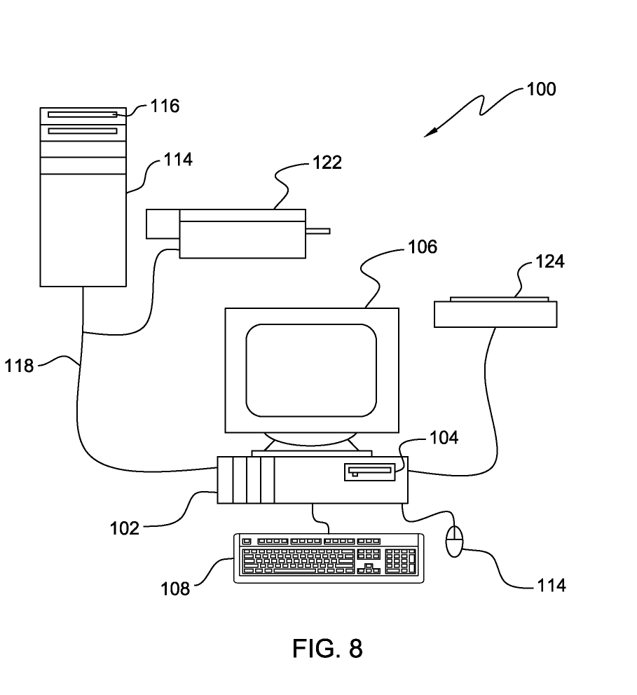

A computer-based system 100 in which a method embodiment of the invention may be carried out is depicted in FIG. 8. The computer-based system 100 includes a processing unit 102, which houses a processor, memory and other systems components (not shown expressly in the drawing) that implement a general purpose processing system, or computer that may execute a computer program product. The computer program product may comprise media, for example a compact storage medium such as a compact disc, which may be read by the processing unit 102 through a disc drive 104, or by any means known to the skilled artisan for providing the computer program product to the general purpose processing system for execution thereby.

The computer program product may comprise all the respective features enabling the implementation of the inventive method described herein, and which—when loaded in a computer system—is able to carry out the method. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product may be stored on hard disk drives within processing unit 102, as mentioned, or may be located on a remote system such as a server 114, coupled to processing unit 102, via a network interface 118 such as an Ethernet interface. Monitor 106, mouse 114 and keyboard 108 are coupled to the processing unit 102, to provide user interaction. Scanner 124 and printer 122 are provided for document input and output. Printer 122 is shown coupled to the processing unit 102 via a network connection, but may be coupled directly to the processing unit. Scanner 124 is shown coupled to the processing unit 102 directly, but it should be understood that peripherals might be network coupled, or direct coupled without affecting the performance of the processing unit 102.

While it is apparent that the invention herein disclosed is well calculated to fulfill the objectives discussed above, it will be appreciated that numerous modifications and embodiments may be devised by those skilled in the art, and it is intended that the appended claims cover all such modifications and embodiments as fall within the true spirit and scope of the present invention.

1. A method of modeling the temporal behavior of clients to develop a predictive system to positively influence client relationships, the method comprising:
establishing for each of a plurality of clients a temporal model for a given time period, said temporal model identifying a plurality of factors as contributing to a specified relationship with said each client over the given time period, including, for each of a plurality of different stages of the given time period, identifying one or more of said factors as contributing to the specified relationship with said each client;
identifying one of said plurality of clients as a model client for another client; and
using the temporal model of said model client to predict one or more of the plurality of factors as contributing to a specified relationship with said another client at a specified time.

2. The method according to claim 1, wherein the establishing for each of a plurality of clients a temporal model includes:
surveying the plurality of clients at least a plurality of times to develop the temporal models, including, for each of the plurality of clients, using the survey to measure a set of defined factors, and using said defined factors to develop the temporal model for said each client.

3. The method according to claim 2, wherein each of said defined factors includes one or more sub-parameters.

4. The method according to claim 1, further comprising calculating a defined client loyalty value for each of the plurality of clients from one or more of the factors identified as contributing to the relationship with said each client.

5. The method according to claim 4, wherein the calculating the client loyalty value includes using a defined equation to calculate the client loyalty value for said each client.

6. The method according to claim 5, further comprising setting a target value for the client loyalty value.

7. The method according to claim 6, wherein the defined equation includes, for each of the plurality of clients, variables representing all of the factors identified as contributing to the relationship with said each client.

8. The method according to claim 7, wherein the only variables in said defined equation represent the factors identified as contributing to the relationship with said each client.

9. The method according to claim 1, wherein each of the clients has a respective one account, and said specified time is a specified age of the account of the another client.

10. The method according to claim 9, wherein the temporal model of the model client is used, before the account of the another client reaches said specified age, to predict the one or more factors as contributing to the relationship with the another client when the account of the another client is at the specified time.

11. A modeling system for modeling and using the temporal behavior of clients to develop a predictive system to positively influence client relationships, the modeling system comprising one or more processing units configured for:
establishing for each of a plurality of clients a temporal model for a given time period, said temporal model identifying a plurality of factors as contributing to a specified relationship with said each client over the given time period, including, for each of a plurality of different stages of the given time period, identifying one or more of said factors as contributing to the specified relationship with said each client;
identifying one of said plurality of clients as a model client for another client; and
using the temporal model of said model client to predict one or more of the plurality of factors as contributing to a specified relationship with said another client at a specified time.

12. The modeling system according to claim 11, wherein:
the establishing for each of a plurality of clients a temporal model includes using survey data from a plurality of surveys from the plurality of clients to develop the temporal model for said each client; and
the survey data includes, for each of the plurality of clients, measurements for a set of defined factors and selected ones of said defined factors are used to develop the temporal model for said each client.

13. The modeling system according to claim 11, wherein said one or more processing units are further configured for calculating a defined client loyalty value for each of the plurality of clients from one or more of the factors identified as contributing to the relationship with said each client.

14. The modeling system according to claim 13, wherein a target value is set for the client loyalty value.

15. The modeling system according to claim 13, wherein the client loyalty value is calculated, for each of the clients, using a defined equation that includes variables representing all the factors identified as contributing to the relationship with said each client.

16. An article of manufacture comprising:
at least one tangible computer readable medium having computer readable program code logic tangibly embodied therein for modeling and using the temporal behavior of clients to develop a predictive system to positively influence client relationships, said computer readable program code logic, when executing, performing the following:
establishing for each of a plurality of clients a temporal model for a given time period, said temporal model identifying a plurality of factors as contributing to a specified relationship with said each client over the given time period, including, for each of a plurality of different stages of the given time period, identifying one or more of said factors as contributing to the specified relationship with said each client;
identifying one of said plurality of clients as a model client for another client; and
using the temporal model of said model client to predict one or more of the plurality of factors as contributing to a specified relationship with said another client at a specified time.

17. The article of manufacture according to claim 16, wherein said computer readable program code logic, when executing, further performs calculating a defined client loyalty value for each of the plurality of clients from variables representing more of the factors identified as contributing to the relationship with said each client.

18. The article of manufacture according to claim 17, wherein a target value is set for the client loyalty value.

19. The article of manufacture according to claim 16, wherein each of the clients has a respective one account, and said specified time is a specified age of the account of the other client.

20. (canceled)

21. The method according to claim 1, further comprising:
using a computer system, implementing a temporal behavior modeling program, to perform the using the temporal model of said model client to predict one or more of the plurality of factors as contributing to the specified relationship with said another client.
